(19) United States
(12) Patent Application Publication
(10) Pub. No.: US 2018/0230678 A1
(43) Pub. Date: Aug. 16, 2018

(54) CONSTRUCTION METHOD, WORK MACHINE CONTROL SYSTEM, AND WORK MACHINE

(71) Applicant: Komatsu Ltd., Tokyo (JP)

(72) Inventors: Tomohiro Taira, Tokyo (JP); Nao Asada, Tokyo (JP); Kentaro Takayama, Tokyo (JP)

(21) Appl. No.: 15/750,209

(22) PCT Filed: Oct. 5, 2016
(86) PCT No.: PCT/JP2016/079702

§ 371 Date: Feb. 5, 2018

(30) Foreign Application Priority Data
Oct. 5, 2015 (JP) 2015-198079

(51) Int. Cl. E02F 9/26; E02F 9/20; B60R 1/00; G05D 1/02; G01C 11/06; G01B 11/245

(52) U.S. Cl. CPC E02F 9/262; E02F 9/205; B60R 1/00; E02F 3/32; G01C 11/06; G01B 11/245; G05D 1/0276

(57) ABSTRACT

A work machine control system includes a shape detection unit and a construction information generation unit. The shape detection unit detects an object to be constructed and outputs shape information representing a three-dimensional shape of the object. The construction information generation unit acquires the shape information from the shape detection unit and determines, using the shape information, target construction information as a target of construction of the object to be constructed.

### FIELD

The present invention relates to a construction method, a work machine control system, and a work machine.

### BACKGROUND

There have been work machines including imaging devices. Patent Literature 1 describes a technology for creating construction plan image data on the basis of construction plan data stored in a storage unit and positional information of a stereo camera, superimposing the construction plan image data on current image data captured by the stereo camera into a composite image, and three-dimensionally display the superimposed composite image on a three-dimensional display device.

### CITATION LIST

### Patent Literature

Patent Literature 1: Japanese Patent Application Laid-open No. 2013-36243 A

### SUMMARY

### Technical Problem

When constructing an object, a worker measures the object to be constructed to determine the existing shape of the object, generating design information about the object to be constructed on the basis of the obtained shape of the object. In accordance with such a method, a target shape can be determined in construction of the object to be constructed, but it takes time and effort to set a measuring device, to remove the measuring device after measurement, or to perform measurement.

An object of the present invention is to reduce time and effort to determine a target shape in construction of the object to be constructed.

### Solution to Problem

According to an aspect of the present invention, a construction method comprises: acquiring information about an object detected by an object detection unit of a work machine; determining shape information representing a three-dimensional shape of the object on the basis of the acquired information about the object; and determining, by using the shape information, target construction information as a target of construction of the object by a work machine.

It is preferable that the work machine includes a working unit, and the working unit is controlled on the basis of the target construction information.

It is preferable that the target construction information is obtained by changing a position of a surface of the object included in the shape information.

It is preferable that the changing the position of the surface of the object includes offsetting the surface of the object by a predetermined depth or a predetermined height.

It is preferable that the changing the position of the surface of the object includes providing a slope having a predetermined angle of inclination on the surface of the object.

According to an aspect of the present invention, a work machine control system comprises: an object detection unit configured to detect an object and output information about the object; a shape detection unit configured to, by using information about the object detected by the object detection unit, output shape information representing a three-dimensional shape of the object; and a construction information generation unit configured to acquire the shape information from the shape detection unit and determine, by using the shape information, target construction information as a target of construction of the object.

It is preferable that the work machine control system, further comprises a working unit control unit configured to control the working unit on the basis of the target construction information.

It is preferable that the work machine control system, further comprises a display device configured to display a shape of the target represented by the target construction information.

It is preferable that the construction information generation unit is configured to change a position of a surface of the object included in the shape information to determine the target construction information.

It is preferable that the shape detection unit includes at least two imaging devices.

According to an aspect of the present invention, a work machine comprises the work machine control system.

According to an aspect of the present invention, a work machine comprises the work machine control system, the work machine being remotely controlled by a remote control device.

According to the present invention, less time and effort is required when a target shape is determined in construction of an object to be constructed.

### BRIEF DESCRIPTION OF DRAWINGS

FIG. 1 is a perspective view of an excavator including an imaging device control system according to a first embodiment.

FIG. 2 is a perspective view of a portion around a driver's seat of the excavator according to the first embodiment.

FIG. 3 is a diagram illustrating a work machine control system and a work machine management system according to an embodiment.

FIG. 4 is a diagram illustrating an exemplary hardware configuration of an excavator and a management device.

FIG. 5 is a diagram illustrating an example of a construction site constructed by the excavator according to the first embodiment.

FIG. 6 is a diagram illustrating shape information determined by a work machine control system according to the first embodiment.

FIG. 7 is a diagram illustrating an excavator being inclined relative to a gravity direction.

FIG. 8 is a diagram illustrating an example of an image obtained by imaging an object by using at least a pair of imaging devices while the excavator is inclined relative to the gravity direction.

FIG. 9 is a diagram illustrating an example of a process of determining shape information by a control system according to the first embodiment.

FIG. 10 is a table illustrating an example of a data file of shape information determined by the control system according to the first embodiment.

FIG. 11 is a diagram illustrating target construction information generated by the work machine control system according to the first embodiment.

FIG. 12 is a diagram illustrating target construction information generated by the work machine control system according to the first embodiment.

FIG. 13 is a diagram illustrating target construction information generated by the work machine control system according to the first embodiment.

FIG. 14 is a flowchart illustrating an example of a process of a construction method according to the first embodiment.

FIG. 15 is a flowchart illustrating an example of a process of a construction method according to a second embodiment.

FIG. 16 is a flowchart illustrating an example of a process of a construction method according to a third embodiment.

FIG. 17 is a flowchart illustrating an example of a process of a construction method according to a first modification of the third embodiment.

FIG. 18 is a flowchart illustrating an example of a process of a construction method according to a second modification of the third embodiment.

FIG. 19 is a diagram illustrating the construction method according to the second modification of the third embodiment.

FIG. 20 is a diagram illustrating the construction method according to the second modification of the third embodiment.

FIG. 21 is a diagram illustrating a management system according to a fourth embodiment.

### DESCRIPTION OF EMBODIMENTS

Modes for carrying out the present invention (embodiments) will be described below in detail with reference to the drawings.

### First Embodiment

<Overall Configuration of Excavator>

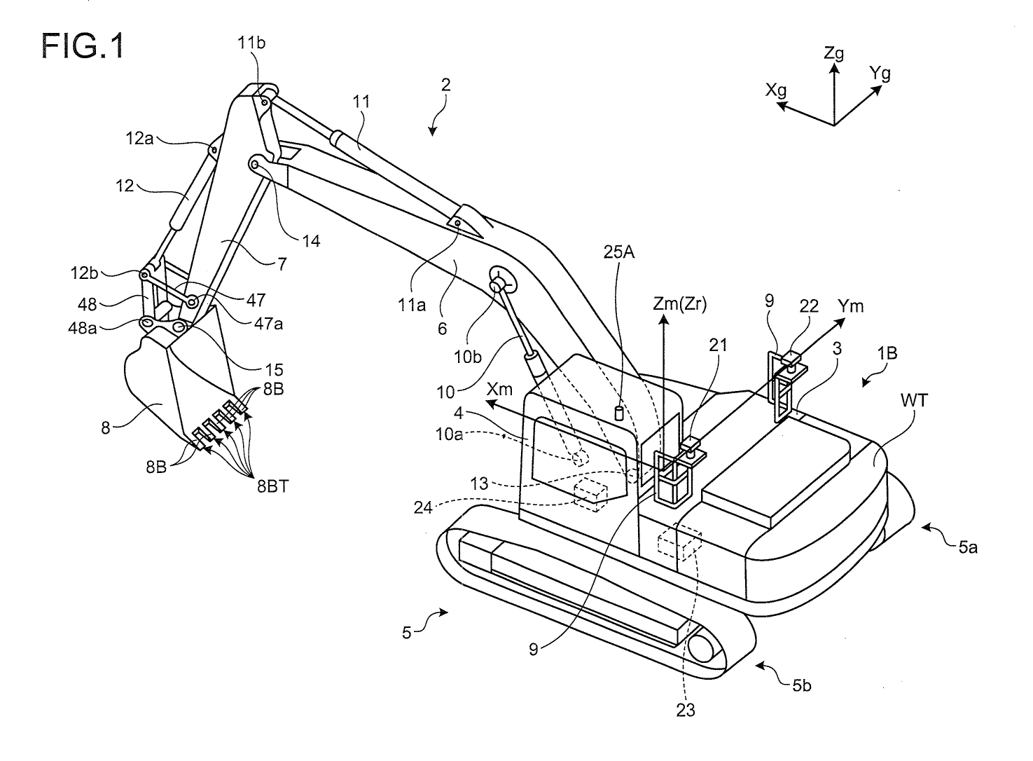

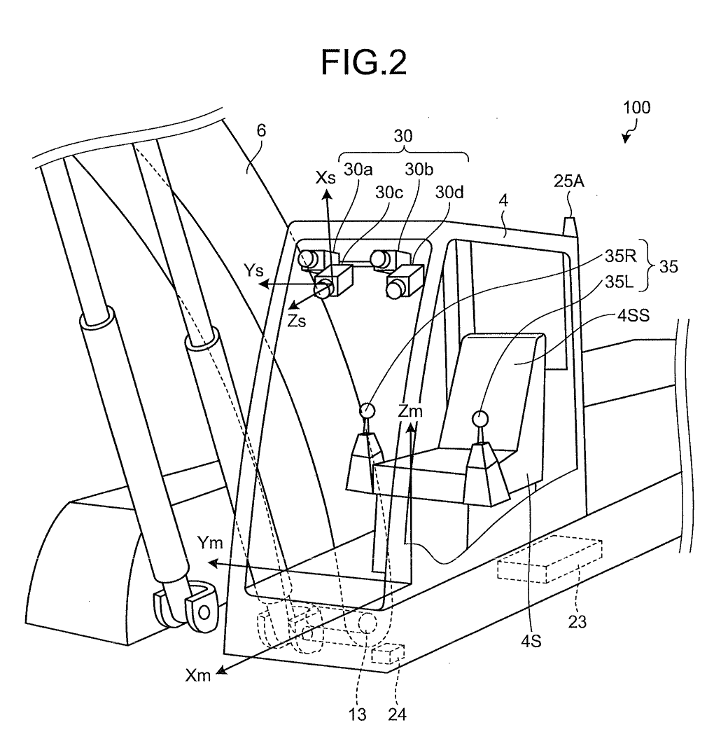

FIG. 1 is a perspective view of an excavator 1 including an imaging device control system according to a first embodiment. FIG. 2 is a perspective view of a portion around a driver's seat of the excavator 1 according to the first embodiment. The excavator 1 as a work machine includes a vehicle body 1B and a working unit 2. The vehicle body 1B includes a swing body 3, a cab 4, and a travel body 5. The swing body 3 is swingably mounted about a swing axis Zr to the travel body 5. The swing body 3 houses devices such as a hydraulic pump and an engine.

The working unit 2 is swingably mounted to the swing body 3. Handrails 9 are mounted on top of the upper swing body 3. Antennas 21 and 22 are mounted to the respective handrails 9. The antennas 21 and 22 are an antenna for real time kinematic-global navigation satellite systems (RTK-GNSS, GNSS refers to a global navigation satellite system). The antennas 21 and 22 are arranged in a direction of a Ym-axis of a vehicle body coordinate system (Xm, Ym, Zm) and separated from each other by a predetermined distance. The antennas 21 and 22 receive GNSS radio waves and output signals in accordance with the received GNSS radio waves. The antennas 21 and 22 may be an antenna for global positioning system (GPS).

The cab 4 is disposed on the front portion of the swing body 3. The cab 4 has a roof to which an antenna 25A for communication is mounted. The travel body 5 includes tracks 5a and 5b. The tracks 5a and 5b are rotated to travel the excavator 1.

The working unit 2 is mounted on a front portion of the vehicle body 1B and includes a boom 6, an arm 7, a bucket 8 as a working implement, a boom cylinder 10, an arm cylinder 11, and a bucket cylinder 12. In the embodiment, the vehicle body 1B has a front side positioned in a direction from a backrest 4SS of the driver's seat 4S to an operation device 35 as illustrated in FIG. 2. The vehicle body 1B has a rear side positioned in a direction from the operation device 35 to the backrest 4SS of the driver's seat 4S. The vehicle body 1B has a front portion which is a portion on the front side of the vehicle body 1B and is positioned on the opposite side to a counterweight WT of the vehicle body 1B. The operation device 35 is a device for operating the working unit 2 and the swing body 3 and includes a right lever 35R and a left lever 35L.

The boom 6 has a base end portion turnably mounted on the front portion of the vehicle body 1B via a boom pin 13. That is, the boom pin 13 corresponds to a turning center of the boom 6 relative to the swing body 3. The arm 7 has a base end portion turnably mounted on a top end portion of the boom 6 via an arm pin 14. That is, the arm pin 14 corresponds to a turning center of the arm 7 relative to the boom 6. The arm 7 has a top end portion on which the bucket 8 is turnably mounted via a bucket pin 15. That is, the bucket pin 15 corresponds to a turning center of the bucket 8 relative to the arm 7.

Each of the boom cylinder 10, the arm cylinder 11, and the bucket cylinder 12 illustrated in FIG. 1 is a hydraulic cylinder driven by hydraulic pressure. The boom cylinder 10 has a base end portion turnably mounted on the swing body 3 via a boom cylinder foot pin 10a. The boom cylinder 10 has a top end portion turnably mounted on the boom 6 via a boom cylinder top pin 10b. The boom cylinder 10 is extended and contracted by hydraulic pressure to drive the boom 6.

The arm cylinder 11 has a base end portion turnably mounted on the boom 6 via an arm cylinder foot pin 11a. The arm cylinder 11 has a top end portion turnably mounted on the arm 7 via an arm cylinder top pin 11b. The arm cylinder 11 is extended and contracted by hydraulic pressure to drive the arm 7.

The bucket cylinder 12 has a base end portion turnably mounted on the arm 7 via a bucket cylinder foot pin 12a. The bucket cylinder 12 has a top end portion turnably mounted on one end of a first link member 47 and on one end of a second link member 48, via a bucket cylinder top pin 12b. The other end of the first link member 47 is turnably mounted on the top end portion of the arm 7 via a first link pin 47a. The other end of the second link member 48 is turnably mounted on the bucket 8 via a second link pin 48a. The bucket cylinder 12 is extended and contracted by hydraulic pressure to drive the bucket 8.

The bucket 8 includes a plurality of teeth 8B. The plurality of teeth 8B is aligned in a width direction of the bucket 8. Each of the teeth 8B has an end formed as a tooth point 8BT. The bucket 8 is an example of the working implement. The working implement is not limited to the bucket 8. The working implement may be a tilt bucket, a slope finishing bucket, a rock breaking attachment including a rock breaking tip, or the like.

The swing body 3 includes a position detection device 23 and an inertial measurement unit (IMU) 24 as an example of an attitude detection device. Signals are input from the antennas 21 and 22 to the position detection device 23. The position detection device 23 uses signals from the antennas 21 and 22 to detect and output the current positions of the antennas 21 and 22 and the orientation of the swing body 3 in a global coordinate system (Xg, Yg, Zg). The orientation of the swing body 3 represents a direction of the swing body 3 in the global coordinate system. The direction of the swing body 3 may be, for example, represented by a direction of the swing body 3 in a front/rear direction around a Zg-axis of the global coordinate system. An azimuth angle represents the rotation angle of a reference axis in the front/rear direction of the swing body 3, around the Zg-axis of the global coordinate system. The orientation of the swing body 3 is represented by the azimuth angle. In the present embodiment, the position detection device 23 calculates an azimuth angle from a relative position of the two antennas 21 and 22.

<Imaging Device>

As illustrated in FIG. 2, the excavator 1 includes a plurality of imaging devices 30a, 30b, 30c, and 30d, for example, in the cab 4. The plurality of imaging devices 30a, 30b, 30c, and 30d is an example of a detection device for detecting the shape of an object. Hereinafter, when the plurality of imaging devices 30a, 30b, 30c, and 30d are not distinguished from one another, the imaging devices will be appropriately referred to as imaging devices 30. The imaging devices 30a and 30c of the plurality of imaging devices 30 are disposed near the working unit 2. The type of each imaging device 30 is not limited, but in the embodiment, for example, an imaging device including a couple charged device (CCD) image sensor or a complementary metal oxide semiconductor (CMOS) image sensor is employed.

As illustrated in FIG. 2, the imaging device 30a and the imaging device 30b are disposed at a predetermined interval to be directed in the same direction or in different directions in the cab 4. The imaging device 30c and the imaging device 30d are disposed at a predetermined interval in the same direction or in different directions in the cab 4. Two of the plurality of imaging devices 30a, 30b, 30c, and 30d are combined to constitute a stereo camera. In the embodiment, a combination of the imaging devices 30a and 30b and a combination of the imaging devices 30c and 30d constitute stereo cameras. In the embodiment, the imaging device 30a and the imaging device 30b are directed upward, and the imaging device 30c and the imaging device 30d are directed downward. At least the imaging device 30a and the imaging device 30c are directed to the front side of the excavator 1, specifically, to the front side of the swing body 3 in the embodiment. The imaging device 30b and the imaging device 30d may be disposed to be directed slightly toward the working unit 2, that is, may be disposed to be directed slightly toward the imaging device 30a and the imaging device 30c.

In the embodiment, the excavator 1 includes four imaging devices 30, but the number of imaging devices 30 of the excavator 1 is desirably at least 2 and is not limited to four. That is because, in the excavator 1, at least a pair of imaging devices 30 constitutes a stereo camera to capture stereo images of the object.

The plurality of imaging devices 30a, 30b, 30c, and 30d is disposed on the front upper side of the cab 4. The upper side is in a direction perpendicular to a ground plane on which the tracks 5a and 5b of the excavator 1 are positioned and away from the ground plane. The ground plane of the tracks 5a and 5b represents a plane defined by at least three non-collinear points in a portion where at least one of the tracks 5a and 5b makes contact with the ground. The lower side is in a direction opposite to that of the upper side, that is, in a direction perpendicular to the ground plane on which the tracks 5a and 5b are positioned and toward the ground plane.

The plurality of imaging devices 30a, 30b, 30c, and 30d capture stereo images of the object positioned in front of the vehicle body 1B of the excavator 1. The object is for example an object to be excavated by the working unit 2. In the present embodiment, a result of capturing stereoscopic images by at least a pair of imaging devices 30 is used to three-dimensionally measure the object. Places where the plurality of imaging devices 30a, 30b, 30c, and 30d are disposed are not limited to the front upper side of the cab 4.

For example, the imaging device 30c is selected, as a reference, from the plurality of imaging devices 30a, 30b, 30c, and 30d. Each of the plurality of four imaging devices 30a, 30b, 30c, and 30d has a coordinate system. The coordinate systems are appropriately referred to as imaging device coordinate systems. In FIG. 2, only a coordinate system (xs, ys, zs) of the imaging device 30c, as a reference, is illustrated. The origin of each imaging device coordinate system is at the center of each of the imaging devices 30a, 30b, 30c, and 30d.

The vehicle body coordinate system (Xm, Ym, Zm) described above is a coordinate system having the origin fixed on the vehicle body 1B, specifically, specifically, the swing body 3 in the present embodiment. In the embodiment, the origin of the vehicle body coordinate system (Xm, Ym, Zm) is, for example, at the center of a swing circle of the swing body 3. The center of the swing circle is on the swing axis Zr of the swing body 3. The vehicle body coordinate system (Xm, Ym, Zm) has a Zm-axis being the swing axis Zr of the swing body 3 and has an Xm-axis extending in the front/rear direction of the swing body 3 and orthogonal to the Zm-axis. The Xm-axis is the reference axis in the front/rear direction of swing body 3. The Ym-axis is an axis orthogonal to the Zm-axis and the Xm-axis and extending in a width direction of the swing body 3. The global coordinate system (Xg, Yg, Zg) described above is a coordinate system measured by GNSS and having the origin fixed on the earth. The vehicle body coordinate system is not limited to the example of the present embodiment. For example, in the vehicle body coordinate system, the origin of the vehicle body coordinate system may be at the center of the boom pin 13. The center of the boom pin 13 represents the center of a cross section of the boom pin 13 taken along a plane orthogonal to a direction in which the boom pin 13 extends, as well as and the center in a direction in which the boom pin 13 extends.

<Control System and Management System>

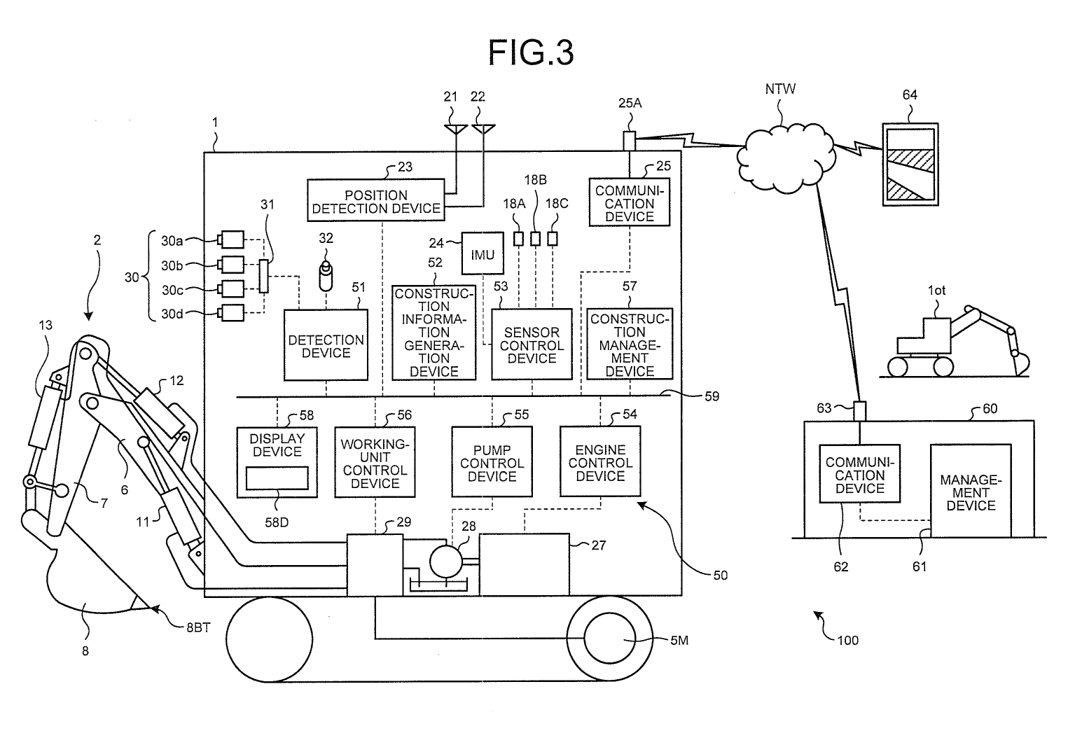

FIG. 3 is a diagram illustrating a work machine control system 50 and a work machine management system 100 according to an embodiment. A system configuration of the control system 50 and the management system 100 illustrated in FIG. 3 is by way of example, and the control system 50 and the management system 100 are not limited to an example of the system configuration of the present embodiment. For example, the control system 50 includes various devices which may not be independent of each other. That is, functions of a plurality of devices may be achieved by one device.

The work machine control system 50 (hereinafter, appropriately referred to as control system 50) includes the plurality of imaging devices 30a, 30b, 30c, and 30d and various control devices for controlling the excavator 1. The plurality of imaging devices and the control devices are included in the vehicle body 1B of the excavator 1 illustrated in FIG. 1, specifically, the swing body 3 in the present embodiment.

The various control devices of the control system 50 includes a detection device 51, a construction information generation device 52, a sensor control device 53, an engine control device 54, a pump control device 55, and a working-unit control device 56, which are illustrated in FIG. 3. In addition, the control system 50 includes a construction management device 57 for managing the condition of the excavator 1 and the status of construction performed by the excavator 1. Furthermore, the control system 50 includes a display device 58 for displaying information about the excavator 1 or a construction guidance image on a screen 58D, and a communication device 25 for communicating with at least one of a management device 61 in a management facility 60 positioned outside the excavator 1, another excavator 1ot, a mobile terminal device 64, and the management facility 60. Furthermore, the control system 50 includes the position detection device 23 for acquiring information required to control the excavator 1, and further includes an IMU 24. In the present embodiment, the control system 50 desirably has at least the detection device 51 and the construction information generation device 52.

In the embodiment, the detection device 51, the construction information generation device 52, the sensor control device 53, the engine control device 54, the pump control device 55, the working-unit control device 56, the construction management device 57, the display device 58, the position detection device 23, and the communication device 25 are connected to a signal line 59 for communication with one another. In the first embodiment, a communication standard using the signal line 59 employs a controller area network (CAN), but the communication standard is not limited thereto. Hereinafter, the excavator 1 may represent various electronic devices, such as the detection device 51 and the construction information generation device 52 of the excavator 1.

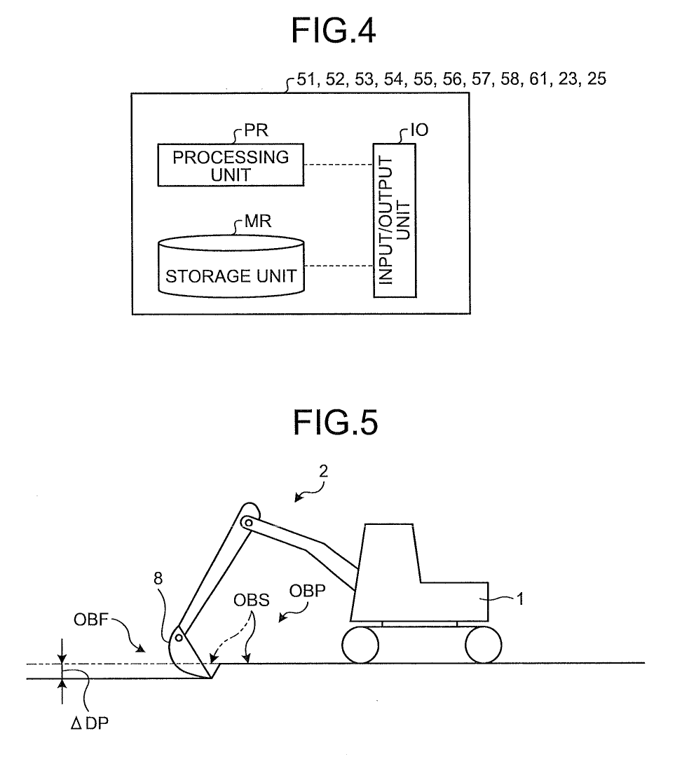

FIG. 4 is a diagram illustrating an exemplary hardware configuration of the excavator 1 and the management device 61. In the embodiment, the detection device 51, the construction information generation device 52, the sensor control device 53, the engine control device 54, the pump control device 55, the working-unit control device 56, the construction management device 57, the display device 58, the position detection device 23, and the communication device 25, all of which are included in the excavator 1, and the management device 61 respectively include a processing unit PR, a storage unit MR, and an input/output unit IO, as illustrated in FIG. 4. The processing unit PR is achieved by a processor, such as a central processing unit (CPU), and a memory.

The storage unit MR employs at least one of a volatile or non-volatile semiconductor memory, a magnetic disk, a flexible disk, and a magneto-optical disk. The volatile or non-volatile semiconductor memory includes a random access memory (RAM), a random access memory (ROM), a flash memory, an erasable programmable random access memory (EPROM), or an electrically erasable programmable random access memory (EEPROM).

The input/output unit IO is an interface circuit which is used to transmit and receive data, signal, and the like by the excavator 1 or the management device 61 to and from another device and an internal device. The internal device includes the signal line 59 in the excavator 1.

The excavator 1 and the management device 61 store computer programs for causing the respective processing units PR to achieve the functions of the excavator 1 and the management device 61, respectively, in the storage units MR. The processing unit PR of the excavator 1 and the processing unit PR of the management device 61 execute the computer programs read from the storage units MR to achieve the functions of the excavator 1 and the management device 61. Various devices, electronic devices, and the management device 61 of the excavator 1 may be achieved by dedicated hardware, or a plurality of processing circuits may achieve the functions of the various devices, electronic devices, and the management device 61 in cooperation with one another. Next, the various devices and electronic devices of the excavator 1 will be described.

The detection device 51 performs stereoscopic image processing on a pair of images of the object captured by at least a pair of imaging devices 30 to determine a position of the object, in particular, the coordinates of the object in a three-dimensional coordinate system. As described above, the detection device 51 uses a pair of images obtained by imaging the same object by using at least a pair of imaging devices 30 to three-dimensionally measure the object. That is, at least a pair of imaging devices 30 and the detection device 51 three-dimensionally measure the object in a stereoscopic manner. The stereoscopic image processing is a procedure to obtain a distance to the object on the basis of two images obtained by observing the same object by using two different imaging devices 30. The distance to the object is represented as, for example, a distance image visualized by shading according to distance information.

The detection device 51 acquires information about the object detected by at least a pair of imaging devices 30 to determine shape information representing a three-dimensional shape of the object on the basis of the acquired information about the object. In the present embodiment, at least a pair of imaging devices 30 images the object to generate and output information about the object. The information about the object represents an image obtained by imaging an object to be constructed by using at least a pair of imaging devices 30. The detection device 51 performs image processing on the image of the object in a stereoscopic manner to determine and output the shape information.

In the present embodiment, the object detected by the imaging device 30 is an object which is to be constructed (hereinafter, appropriately referred to as an object to be constructed) and a constructed object. In the present embodiment, the object to be constructed and the constructed object are desirably an object to be constructed and a constructed object for at least one of the excavator 1 including the imaging device 30, the other excavator 1ot, a work machine other than the excavator, and the worker.

In the present embodiment, at least a pair of imaging devices 30 corresponds to an object detection unit which detects the object and outputs information about the object. The detection device 51 corresponds to a shape detection unit, which uses information about the object detected by at least a pair of imaging devices 30 and outputs shape information representing a three-dimensional shape of the object. Instead of at least a pair of imaging devices 30, a 3D scanner, such as a laser scanner, may be used. The 3D scanner has the functions of the object detection unit and the shape detection unit to detect the object and output shape information representing a three-dimensional shape of the object.

To the detection device 51, a hub 31 and an imaging switch 32 are connected. To the hub 31, the plurality of imaging devices 30a, 30b, 30c, and 30d is connected. The imaging devices 30a, 30b, 30c, and 30d may be connected to the detection device 51 without using the hub 31. Results of imaging by the imaging devices 30a, 30b, 30c, and 30d are input to the detection device 51 via the hub 31. The detection device 51 acquires results of imaging by the imaging devices 30a, 30b, 30c, and 30d, in particular, specifically, images of the object in the present embodiment, via the hub 31. In the present embodiment, when the imaging switch 32 is operated, at least a pair of imaging devices 30 images the object. The imaging switch 32 is disposed in the cab 4 illustrated in FIG. 2. For example, the imaging switch 32 is disposed in the vicinity of the operation device 35, but a place where the imaging switch 32 is disposed is not limited thereto.

The construction information generation device 52 determines and outputs target construction information as target shape information when the excavator 1 constructs the object to be constructed. In the present embodiment, the construction information generation device 52 uses the shape information of the object to be constructed determined by the detection device 51, to determine the target construction information. In the present embodiment, the target construction information is positional information representing a target shape used for construction of the object to be constructed, by three-dimensional coordinates in the global coordinate system. The target construction information may be information about three-dimensional coordinates in a coordinate system other than the global coordinate system. In the present embodiment, the construction information generation device 52 corresponds to a construction information generation unit.

Information about the object to be constructed acquired by at least a pair of imaging devices 30 may be transmitted outside the excavator 1 via the communication device 25, and, for example, the management device 61 may determine the coordinates of the object in the three-dimensional coordinate system. In this configuration, the management device 61 achieves the function of the detection device 51. Furthermore, the management device 61 may achieve the function of the construction information generation device 52. The shape information of the object to be constructed determined by the detection device 51 mounted on the excavator 1 may be transmitted outside the excavator 1 via the communication device 25, and, for example, the management device 61 may determine the target construction information. In this configuration, the management device 61 achieves the function of the construction information generation device 52.

To the sensor control device 53, sensors are connected to detect information about the condition of the excavator 1 and information about a surrounding state of the excavator 1. The sensor control device 53 outputs information from the sensors converted into a format handled by other devices and electronic devices. The information about the condition of the excavator 1 is, for example, information about the attitude of the excavator 1, information about the attitude of the working unit 2, or the like. In an example illustrated in FIG. 3, as sensors for detecting information about the condition of the excavator 1, the IMU 24, a first angle detection unit 18A, a second angle detection unit 18B, and a third angle detection unit 18C are connected to the sensor control device 53, but the sensors are not limited thereto.

The IMU 24 detects and outputs an acceleration and an angular velocity on the IMU 24, that is, an acceleration and an angular velocity on the excavator 1. On the basis of the acceleration and the angular velocity on the excavator 1, the attitude of the excavator 1 is found. In the present embodiment, the first angle detection unit 18A, the second angle detection unit 18B, and the third angle detection unit 18C are, for example, a stroke sensor. The first angle detection unit 18A, the second angle detection unit 18B, and the third angle detection unit 18C detect the stroke lengths of the boom cylinder 10, the arm cylinder 11, and the bucket cylinder 12, respectively, to indirectly detect the turning angle of the boom 6 relative to the vehicle body 1B, the turning angle of the arm 7 relative to the boom 6, and the turning angle of the bucket 8 relative to the arm 7. On the basis of the turning angle of the boom 6 relative to the vehicle body 1B, the turning angle of the arm 7 relative to the boom 6, the turning angle of the bucket 8 relative to the arm 7, which are detected by the first angle detection unit 18A, the second angle detection unit 18B, and the third angle detection unit 18C, respectively, and the dimensions of the working unit 2, the position of the working unit 2 in the position vehicle body coordinate system is found. For example, the position of the working unit 2 corresponds to, for example, the position of a tooth point 8BT of the bucket 8. The first angle detection unit 18A, the second angle detection unit 18B, and the third angle detection unit 18C may use a potentiometer or an inclinometer, instead of the stroke sensor.

The engine control device 54 controls an internal combustion engine 27 as a power generator for the excavator 1. The internal combustion engine 27 is, for example, a diesel engine but is not limited thereto. Furthermore, the power generator for the excavator 1 may be a hybrid power generator obtained by combining the internal combustion engine 27 with a generator motor. The internal combustion engine 27 drives a hydraulic pump 28.

The pump control device 55 controls the flow rate of hydraulic oil discharged from the hydraulic pump 28. In the present embodiment, the pump control device 55 generates a control command signal for adjusting the flow rate of hydraulic oil discharged from the hydraulic pump 28. The pump control device 55 changes a swash plate angle of the hydraulic pump 28 to change the flow rate of hydraulic oil discharged from the hydraulic pump 28 by using the generated control signal. Hydraulic oil discharged from the hydraulic pump 28 is fed to a control valve 29. The control valve 29 feeds hydraulic oil fed from the hydraulic pump 28 to hydraulic devices, such as the boom cylinder 10, the arm cylinder 11, the bucket cylinder 12, and the hydraulic pressure motor 5M, to drive the hydraulic devices.

The working-unit control device 56 controls the working unit 2 on the basis of the target implementation information. Hereinafter, this control is appropriately referred to as working unit control. In the present embodiment, the working unit control represents control for moving, for example, a tooth point 8BT of the bucket 8 along a target surface to be constructed. The target surface to be constructed is a surface representing a target shape upon construction by the excavator 1 and is represented by the target construction information. The working-unit control device 56 corresponds to a working unit control unit. For performance of working unit control, the working-unit control device 56 acquires, for example, the target construction information generated by the construction information generation device 52, controls the control valve 29 so that the tooth point 8BT of the bucket 8 moves along a target surface to be constructed included in the target construction information, and controls the working unit 2. As long as the operation of the working unit 2 is controlled using the target implementation information, working unit control is not limited to control for moving the tooth point 8BT of the bucket 8 along the target surface to be constructed. For example, control for inhibiting the tooth point 8BT from penetrating into the target surface to be constructed, and control for moving the tooth point 8BT within a predetermined range of the target surface to be constructed are included in the working unit control according to the present embodiment. The excavator 1 may not include the working-unit control device 56 to display, as the construction guidance image, a positional relationship between the target construction information obtained by a method, which is described later, and the working unit 2 of the excavator 1, on the screen 58D of the display device 58.

The construction management device 57 collects, for example, shape information determined by the detection device 51, construction results (shape information) of construction of the object to be constructed by the excavator 1, or shape information representing a current terrain of the object to be constructed which is intended to be constructed by the excavator 1. Then, the construction management device 57 transmits the information or results to the management device 61 or the mobile terminal device 64 via the communication device 25. The construction management device 57 may be provided, for example, at the management device 61 provided outside the excavator 1. In this configuration, the construction management device 57 acquires the shape information or construction results from the excavator 1 via the communication device 25.

The construction results are, for example, shape information which is obtained by imaging the object to be constructed after construction by using at least a pair of imaging devices 30 and subjecting a result of the imaging to stereoscopic image processing by the detection device 51. Hereinafter, the shape information representing a current terrain of the object to be constructed which is intended to be constructed is appropriately referred to as current terrain information. Furthermore, the shape information includes shape information representing a construction result and shape information representing a current terrain. The current terrain information is, for example, shape information determined by the detection device 51 on the basis of images of an object to be constructed which is intended to be constructed by the excavator 1, the other excavator 1ot, another work machine, the worker, or the like captured by at least a pair of imaging devices 30.

The construction management device 57, for example, collects the construction results after work of the day to transmit the results to at least one of the management device 61 and the mobile terminal device 64, or collects construction results at a plurality of number of times during work of the day to transmit the results to at least one of the management device 61 and the mobile terminal device 64. The construction management device 57 may transmit shape information before construction to the management device 61 or the mobile terminal device 64, for example, before work in the morning. In the present embodiment, the construction management device 57 collects the construction results and transmits the construction results to the management device 61 or the mobile terminal device 64 twice, for example, at noon and at the end of the work of the day.

In the present embodiment, the display device 58 displays the information about the excavator 1 on the screen 58D, such as a liquid crystal display panel, or displays the construction guidance image on the screen 58D, and further, when the working unit control is performed, the display device 58 determines the position of the working unit 2. In the present embodiment, the position of the tooth point 8BT determined by the display device 58 is the position of the tooth point 8BT of the bucket 8. The display device 58 acquires the current positions of the antennas 21 and 22 detected by the position detection device 23, the turning angles detected by the first angle detection unit 18A, the second angle detection unit 18B, and the third angle detection unit 18C, the dimensions of the working unit 2 stored in the storage unit MR, and output data from the IMU 24, and thereby, the display device 58 determines the position of the tooth point 8BT of the bucket 8. In the present embodiment, the display device 58 determines the position of the tooth point 8BT of the bucket 8, but the position of the tooth point 8BT of the bucket 8 may be determined by a device other than the display device 58.

The communication device 25 communicates with at least one of the management device 61 in the management facility 60, the other excavator 1ot, and the mobile terminal device 64, via a communication line NTW, to transmit and receive information to and from each other. In the present embodiment, the communication device 25 performs wireless communication. Therefore, the communication device 25 includes the antenna 25A for wireless communication. The mobile terminal device 64 is, for example, held by an administrator who manages the work of the excavator 1, but the mobile terminal device 64 is not limited thereto. The communication device 25 may communicate with at least one of the management device 61 in the management facility 60, the other excavator 1ot, and the mobile terminal device 64, through wired communication, to transmit and receive information to and from each other.

The work machine management system 100 includes the management device 61 in the management facility 60 and the excavator 1 including the control system 50. Hereinafter, the work machine management system 100 is appropriately referred to as a management system 100. The management system 100 may further include the mobile terminal device 64. The management system 100 may include a single or a plurality of the excavators 1 including the control systems 50. The management facility 60 includes the management device 61 and a communication device 62. The management device 61 communicates with at least the excavator 1 via the communication device 62 and the communication line NTW. The management device 61 may communicate with the mobile terminal device 64 and the other excavator 1ot. The excavator 1 and at least one of the other excavator 1ot and the work machine may respectively have a wireless communication device to wirelessly communicate with each other directly. Then, at least one of the excavator 1, the other excavator 1ot, and the work machine may have a device or an electronic device to perform such processing as performed by the management device 61 in the management facility 60 or the like.

The management device 61 receives a construction result or current terrain information from the excavator 1 to manage the progress of construction. The management device 61 may use shape information received from the excavator 1 to generate target construction information and may transmit the target construction information to the excavator 1. The management device 61 may generate the target construction information on the basis of design information about the object to be constructed to transmit the target construction information to the excavator 1. The management device 61 may process a construction result received from the excavator 1 into a moving image of construction progress information to be displayed on the display device or may transmit information of the moving image to the excavator 1 or the mobile terminal device 64 to display the moving image on the display device 58 of the excavator 1 or on a screen of the mobile terminal device 64. As described above, the generation of the target construction information, which is performed by the management device 61, may be performed by at least one of the excavator 1, the other excavator 1ot, and the other work machine.

<Construction of Object to Be Constructed>

In the first embodiment, the control system 50 images the object to be constructed by at least two of the plurality of imaging devices 30 illustrated in FIG. 2 to obtain shape information being information representing the shape of the object to be constructed. The control system 50 uses the obtained shape information to determine target construction information. When the excavator 1 constructs the object to be constructed, the control system 50 controls the working unit 2 to move in accordance with the determined target construction information.

FIG. 5 is a diagram illustrating an example of a construction site constructed by the excavator 1 according to the first embodiment. In the first embodiment, an object OBP to be constructed with respect to the excavator 1 is the ground. In the present embodiment, the object OBP to be constructed is an area being at least part of the construction site. In the present embodiment, as illustrated in FIG. 5, construction performed on the object OBP to be constructed by the excavator 1 is work of excavating surface soil by a predetermined depth ADP from a surface OBS of the object OBP to be constructed. A portion, on which construction is performed, of the object OBP to be constructed is a constructed portion OBF. The constructed portion OBF may represent a portion which does not require construction, depending on a construction plan. The constructed portion OBF is at least part of the object OBP to be constructed. Next, the shape information determined by the control system 50 will be described.

<Imaging Object and Generating Shape Information>

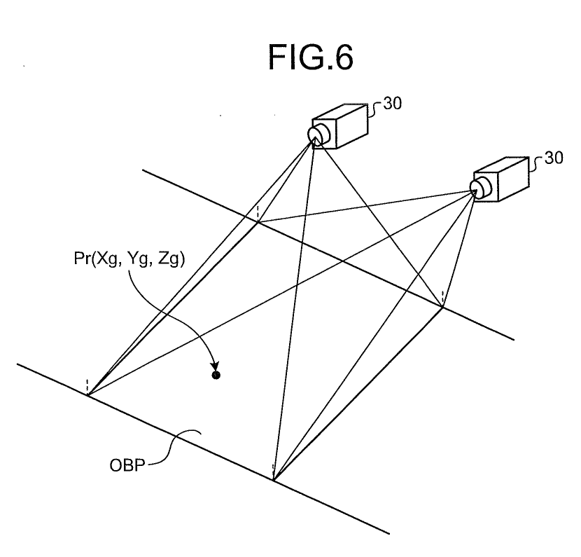

FIG. 6 is a diagram illustrating shape information determined by the work machine control system according to the first embodiment. In this case, the object OBP to be constructed which is a portion intended to be constructed by the excavator 1 is positioned in front of the excavator 1. The shape information is determined from the object OBP to be constructed. When shape information of the object OBP to be constructed is generated, the control system 50 causes at least a pair of imaging devices 30 to image the object OBP. In the present embodiment, when the operator of the excavator 1 operates the imaging switch 32 illustrated in FIG. 3 to input an imaging command to the detection device 51, the detection device 51 causes at least a pair of imaging devices 30 to image the object OBP to be constructed.

The detection device 51 of the control system 50 performs stereoscopic image processing on images of the object OBP to be constructed, which are captured by at least a pair of imaging devices 30 to determine the three-dimensional positional information of the object OBP to be constructed, three-dimensional positional information in the present embodiment. The positional information of the object OBP to be constructed determined by the detection device 51 is information in the coordinate systems of the imaging devices 30, so that the positional information of the object OBP is converted into positional information in the global coordinate system. The positional information of the object to be constructed in the global coordinate system is the shape information. In the present embodiment, the shape information is information including at least one position Pr (Xg, Yg, Zg) of the surface OBS of the object OBP to be constructed in the global coordinate system. The position Pr (Xg, Yg, Zg) represents coordinates in the global coordinate system.

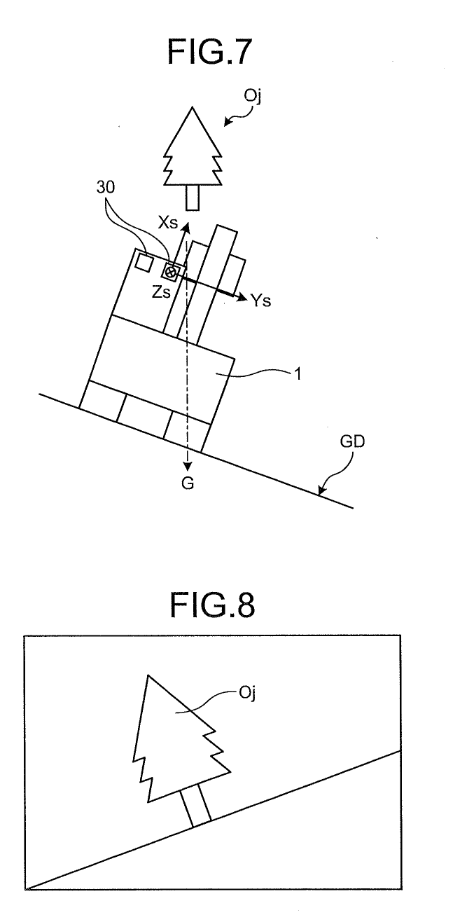

FIG. 7 is a diagram illustrating the excavator 1 being inclined relative to a gravity direction G. FIG. 8 is a diagram illustrating an example of an image obtained by imaging an object Oj by using at least a pair of imaging devices 30 while the excavator 1 is inclined relative to the gravity direction G. When at least a pair of imaging devices 30 images the object Oj while the excavator 1 is set on a slope GD, an imaging device coordinate system (xs, ys, zs) is inclined relative to the gravity direction G. In an image obtained in such a state, the object Oj is inclined as illustrated in FIG. 8. Therefore, when stereoscopic image processing is performed on this image to determine shape information, shape information may be influenced by inclination. The control system 50 detects the attitude of the excavator 1 by using the IMU 24 and uses the detected information about the attitude of the excavator 1 to determine the shape information.

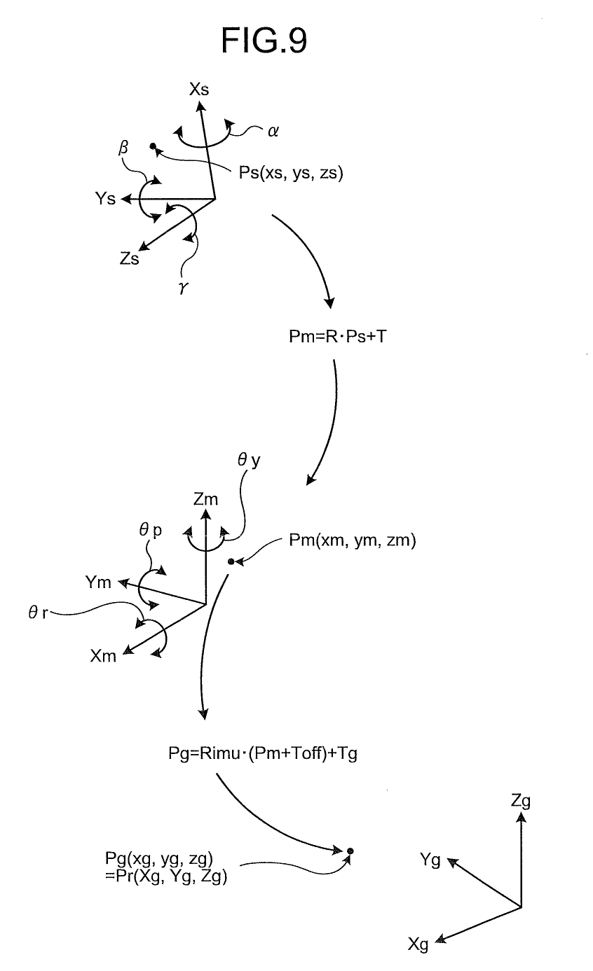

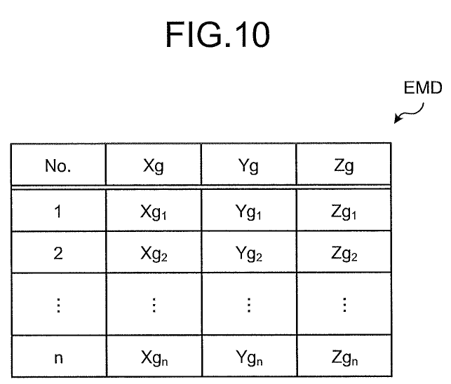

FIG. 9 is a diagram illustrating an example of a process of determining shape information by the control system 50 according to the first embodiment. FIG. 10 is a table illustrating an example of a data file of the shape information determined by the control system 50 according to the first embodiment. A position Ps (xs, ys, zs) of the object OBP to be constructed obtained from images captured by at least a pair of imaging devices 30 is coordinates in the imaging device coordinate system (xs, ys, zs). Since the shape information is coordinates in the global coordinate system (Xg, Yg, Zg), the detection device 51 converts the position Ps (xs, ys, zs) into a position Pg (xs, ys, zs) in the global coordinate system (Xg, Yg, Zg). The position Pg (xs, ys, zs) represents the position Pr (Xg, Yg, Zg) of the surface OBS of the object OBP to be constructed, that is, represents shape information.

The position Ps (xs, ys, zs) in the imaging device coordinate system (xs, ys, zs) is converted into a position Pm (xm, ym, zm) in the vehicle body coordinate system (Xm, Ym, Zm) using formula (1). The position Pm (xm, ym, zm) in the vehicle body coordinate system (Xm, Ym, Zm) is converted into the position Pg (xs, ys, zs) in the global coordinate system (Xg, Yg, Zg) using formula (2).

$$\begin{matrix}Pm = R \cdot Ps + T & ( 1 ) \\ Pg = Rimu \cdot ( Pm + Toff ) + Tg & ( 2 ) \\ R = ( \begin{matrix}1 & 0 & 0 \\ 0 & cos α & - sin α \\ 0 & sin α & cos α\end{matrix} ) ( \begin{matrix}cos β & 0 & sin β \\ 0 & 1 & 0 \\ - sin β & 0 & cos β\end{matrix} ) ( \begin{matrix}cos γ & - sin γ & 0 \\ sin γ & cos γ & 0 \\ 0 & 0 & 1\end{matrix} ) & ( 3 ) \\ T = ( \begin{matrix}{x}_{0} \\ {y}_{0} \\ {z}_{0}\end{matrix} ) & ( 4 ) \\ Rimu = ( \begin{matrix}cos θ y & - sin θ y & 0 \\ sin θ y & cos θ y & 0 \\ 0 & 0 & 1\end{matrix} ) ( \begin{matrix}cos θ p & 0 & sin θ p \\ 0 & 1 & 0 \\ - sin θ p & 0 & cos θ p\end{matrix} ) ( \begin{matrix}1 & 0 & 0 \\ 0 & cos θ r & - sin θ r \\ 0 & sin θ r & cos θ r\end{matrix} ) & ( 5 ) \\ Toff = ( \begin{matrix}{x}_{1} \\ {y}_{1} \\ {z}_{1}\end{matrix} ) & ( 6 ) \\ Tg = ( \begin{matrix}{x}_{2} \\ {y}_{2} \\ {z}_{2}\end{matrix} ) & ( 7 )\end{matrix}$$

In formula (1), R is a rotation matrix expressed by formula (3), and T is a translation vector expressed by a matrix of formula (4). In formula (2), Rimu is a rotation matrix represented by formula (5). Toff is a translation vector expressed by a matrix of formula (6). Toff is an offset value of a distance from the origin of the vehicle body coordinate system to any one of the antennas 21 and 22. Tg is a translation vector of any one of the antennas 21 and 22, expressed by a matrix of formula (7). Each of an angle α, an angle β, and an angle γ in the rotation matrix R represents the inclination of the imaging device coordinate system relative to the vehicle body coordinate system. The angle α, the angle β, and the angle γ are determined in advance, for example, after the plurality of imaging devices 30 is mounted on the excavator 1 and stored in the storage unit of the detection device 51. The matrix T has x₀, y₀, and z₀, each of which represents a distance between the origin of the imaging device coordinate system and the origin of the vehicle body coordinate system. For example, x₀, y₀, and z₀ are measured after the plurality of imaging devices 30 is mounted on the excavator 1 or are determined in advance on the basis of design information of the excavator 1, and x₀, y₀, and z₀ are stored in the storage unit of the detection device 51.

In the rotation matrix Rimu, an angle θr, an angle θp, and an angle θy are a roll angle, a pitch angle, and a yaw angle (or an azimuth angle) of the excavator 1, respectively. The angle θr, the angle θp, and the angle θy represent the attitude of the excavator 1. The angle θr, the angle θp, and the angle θy are determined by the IMU 24 illustrated in FIG. 3 or are determined by the detection device 51 on the basis of a detection value from the IMU 24. The angle θr, the angle θp, and the angle θy are changed according to the change of the attitude of the excavator 1. In the present embodiment, the azimuth angle (orientation data) obtained by a GPS compass constituted by the antennas 21 and 22 and the position detection device 23 may be used instead of the yaw angle θy.

The matrix Toff has x₁, y₁, and z₁ which represent a distance from the origin of the vehicle body coordinate system to each of the positions where the antennas 21 and 22 are disposed as illustrated in FIGS. 1 and 3. For example, x₁, y₁, and z₁ are measured after the antennas 21 and 22 are mounted on the excavator 1 or determined in advance on the basis of the design information of the excavator 1 and x₁, y₁, and z₁ are stored in the storage unit of the detection device 51.

The matrix Tg has x₂, y₂, and z₂ which represent each of the positions of the antennas 21 and 22 in the global coordinate system, detected by the antennas 21 and 22 and the position detection device 23 illustrated in FIGS. 1 and 3. In accordance with a change in position of the excavator 1, in particular, a change in each position of the antennas 21 and 22, x₁, y₁, and z₁ are changed.

The detection device 51 uses formulas (1) to (7) to convert the position Ps (xs, ys, zs) of the object OBP to be constructed, obtained from images captured by at least a pair of imaging devices 30, into a position Pg (xg, yg, zg) in the global coordinate system. At that time, the detection device 51 acquires the angle θr, the angle θp, and the angle θy from the IMU 24 and the positions of the antennas 21 and 22 in the global coordinate system from the position detection device 23, and uses the acquired angles and positions for the conversion. As described above, the detection device 51 may use an azimuth angle θd calculated by the position detection device 23 by using the relative position of the two antennas 21 and 22, instead of the angle θy. The detection device 51 defines the position Pg (xg, yg, zg) obtained by the conversion, as the position Pr (Xg, Yg, Zg) of the surface OBS of the object OBP to be constructed, that is, as the shape information. In the present embodiment, the position Pr of the surface OBS of the object OBP to be constructed is represented as an example of the shape information, but the shape information is not limited to the position Pr. For example, the shape information may be a position of the surface of the object OBP to be constructed after construction and a position of the surface of the object OBP to be constructed in the process of construction.

The detection device 51 determines the positions Pr (Xg, Yg, Zg) of the surface OBS of the object OBP to be constructed over the whole area of the object OBP imaged by at least a pair of imaging devices 30. In the present embodiment, as illustrated in FIG. 10, the detection device 51 generates a data file EMD of a predetermined unit of obtained positions Pr (Xg, Yg, Zg). The data file EMD illustrated in FIG. 10 is a set of n (n is an integer of more than 1) positions Pr (Xg, Yg, Zg). The data file EMD also corresponds to the shape information according to the present embodiment.

The predetermined unit includes, for example, a range of the object OBP to be constructed obtained in a single imaging event and a predetermined range of the object OBP to be constructed. The predetermined range of the object OBP to be constructed may be part of a range obtained in a single imaging event or may be a range over the range obtained in a single imaging event. The range over the range obtained in a single imaging event is a range obtained during a plurality of imaging events.

In the present embodiment, when a data file EMD is generated, the detection device 51 causes the storage unit of the detection device 51 to store the generated data file EMD. Then, the detection device 51 uses a position Pr in the data file EMD to generate target construction information. In addition, the construction management device 57 may transmit a data file EMD generated by the detection device 51 from the communication device 25 to at least one of the management device 61, the mobile terminal device 64, and the other excavator 1ot illustrated in FIG. 3. Next, the target construction information will be described.

<Target Construction Information>

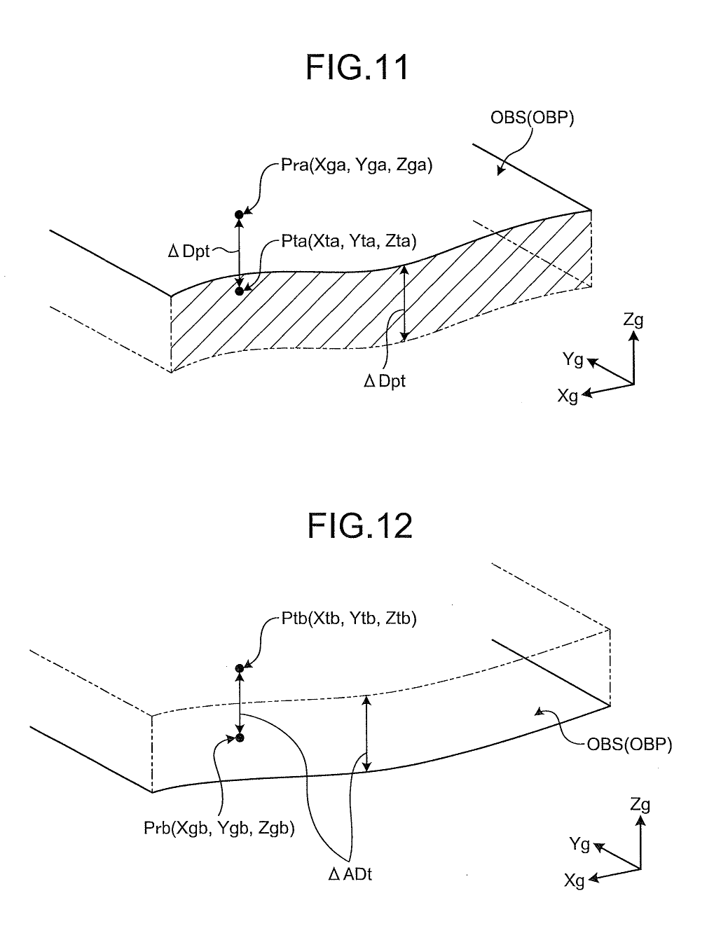

FIGS. 11, 12, and 13 are diagrams illustrating the target construction information generated by the work machine control system 50 according to the first embodiment. In the present embodiment, the construction information generation device 52 illustrated in FIG. 3 uses shape information generated by the detection device 51 to determine target construction information, that is, positional information of the target shape for construction of the object OBP to be constructed. In the present embodiment, as illustrated in FIGS. 11 and 12, the construction information generation device 52 processes information representing the position of the surface OBS of the object OBP to be constructed included in the shape information, changes the position of the surface OBS, and obtains the target construction information.

FIG. 11 illustrates a construction example of removing (excavating) a range of a distance ΔDPt from the surface OBS of the object OBP to be constructed. In this case, the construction information generation device 52 determines a position Pta (Xta, Yta, Zta) obtained by reducing the height of a position Pra (Xga, Yga, Zga) of the surface OBS of the object OBP to be constructed by the distance ADPt. In the present embodiment, the construction information generation device 52 reduces ΔDPt from Zga of the position Pra (Xga, Yga, Zga) to move the position Pra (Xga, Yga, Zga) to a position at a height reduced by the distance ΔDPt. Accordingly, the position Pta (Xta, Yta, Zta) is changed to a position Pta (Xga, Yga, Zga-ΔDPt). Thus obtained position Pta (Xta, Yta, Zta) is defined as the target construction information. The construction information generation device 52 obtains shape information, a data file EMD in the present embodiment, from the detection device 51 illustrated in FIG. 3, reduces ADPt from the value of Zg for all positions Pr (Xg, Yg, Zg) included in the data file EMD, and generates the target construction information.

FIG. 12 illustrates a construction example of adding a material, such as soil or rocks within a range of distance ΔADt from the surface OBS of the object OBP to be constructed. In this case, the construction information generation device 52 determines a position Ptb (Xtb, Ytb, Ztb) obtained by increasing the height of a position Prb (Xgb, Ygb, Zgb) of the surface OBS of the object OBP to be constructed by the distance ΔADt. In the present embodiment, the construction information generation device 52 adds ΔADt to Zg of the position Prb (Xgb, Ygb, Zgb) to move the position Prb (Xgb, Ygb, Zgb) to a position at a height increased by the distance ΔADt. Accordingly, the position Ptb (Xtb, Ytb, Ztb) is changed to a position Ptb (Xgb, Ygb, Zgb+ΔADt). Thus, obtained position Ptb (Xtb, Ytb, Ztb) is defined as the target construction information. The construction information generation device 52 obtains shape information, a data file EMD in the present embodiment, from the detection device 51 illustrated in FIG. 3, adds ΔADPt to the value of Zg for all positions Pr (Xg, Yg, Zg) included in the data file EMD, and generates the target construction information.

As described above, constructions illustrated in FIGS. 11 and 12 are constructions of changing (offsetting) the surface OBS of the object OBP to be constructed to a predetermined depth (ΔDpt) or a predetermined height (ΔADt). In addition, the control system 50 may be adapted, for example, to construction of providing a slope having a predetermined angle of inclination on the surface OBS of the object OBP to be constructed. Such construction is performed, for example, to construct well-drained terrain. After the detection device 51 generates shape information on the basis of images captured by at least a pair of imaging devices 30, the construction information generation device 52 subtracts or adds a predetermined distance from or to a Zg coordinate of the position of the surface OBS represented by the shape information to generate the target construction information in which a predetermined slope is provided on the surface OBS. In this case as well, the construction information generation device 52 processes the information representing the position of the surface OBS of the object OBP to be constructed included in the shape information, changes the position of the surface OBS, and obtains the target construction information.

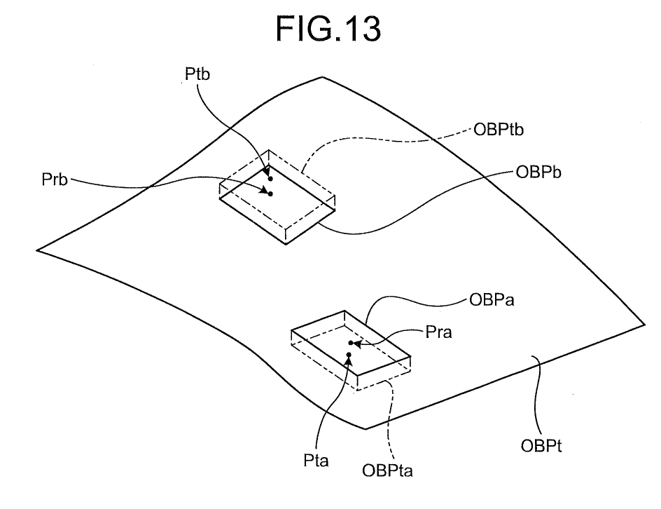

In a wide construction site, as illustrated in FIG. 13, objects OBPa and OBPb to be constructed captured by at least a pair of imaging devices 30 may be part of an object OBPt to be constructed as the whole construction site. Ranges OBPta and OBPtb having positions Pta and Ptb as the target construction information, obtained from the positions Pra and Prb on the surfaces of the objects OBPa and OBPb to be constructed, are also information being part of the whole construction site. The construction management device 57 may use a difference between shape information and target construction information obtained from the shape information to determine the amount of soil to be removed from the object OBP to be constructed or the amount of soil to be added to the object OBP to be constructed.

When the construction management device 57 is provided, for example, at the management device 61 provided outside the excavator 1, the construction management device 57 acquires the shape information from the excavator 1 via the communication device 25. The construction management device 57 uses a difference between the acquired shape information and the target construction information obtained from the shape information, to determine the amount of soil to be removed from the object OBP to be constructed or the amount of soil to be added to the object OBP to be constructed. In this configuration, the construction management device 57 acquires the shape information from the excavator 1 to generate the target construction information. The construction management device 57 may acquire the shape information and the target construction information from the excavator 1 to determine the amount of soil to be removed from the object OBP to be constructed or the amount of soil to be added to the object OBP to be constructed.

The construction information generation device 52 generates target construction information and causes the storage unit of the construction information generation device 52 to store the target construction information. The target construction information stored in the storage unit of the construction information generation device 52 is used as a target value for performing working unit control by the working-unit control device 56. In the present embodiment, the working-unit control device 56 controls the working unit 2 of the excavator 1 so that the working unit 2, in particular, a tooth point 8BT of the bucket 8, moves in accordance with the target construction information. That is, the working-unit control device 56 moves the tooth point 8BT of the bucket 8 along a target shape represented by the target construction information and used for construction of the object to be constructed. The construction management device 57 may transmit the target construction information generated by the construction information generation device 52 from the communication device 25 to at least one of the management device 61, the mobile terminal device 64, and the other excavator 1ot, which are illustrated in FIG. 3. Next, an example of a process of the construction method according to the present embodiment will be described.

<Example of Process of Construction Method According to First Embodiment>

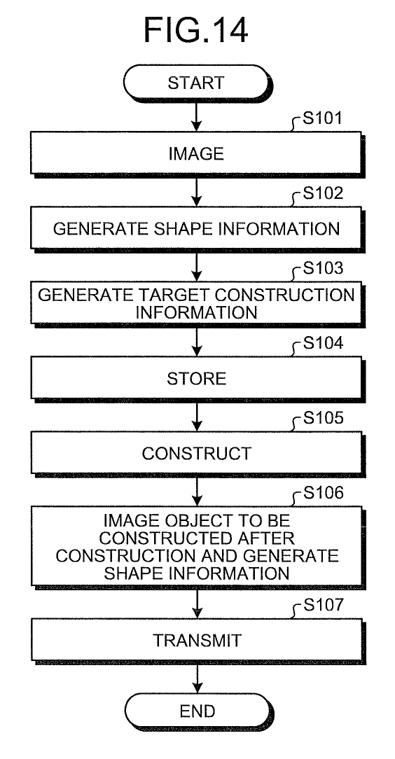

FIG. 14 is a flowchart illustrating an example of a process of a construction method according to the first embodiment. The excavator 1 including the control system 50 performs the construction method according to the present embodiment. More specifically, the control system 50 determines object shape information of the OBP to be constructed to generate target construction information on the basis of the obtained shape information. Then, the control system 50 controls the working unit 2 to move in accordance with the target construction information.

When the imaging switch 32 illustrated in FIG. 3 is operated by the operator, an imaging command for causing the imaging device 30 to image the object OBP to be constructed is transmitted from the imaging switch 32 to the control system 50 and is input to the detection device 51. In step S101, when the imaging command is input, the detection device 51 causes at least a pair of imaging devices 30 to image the object OBP to be constructed. In step S102, the detection device 51 performs stereoscopic image processing on images captured by at least a pair of imaging devices 30, determines the position (three-dimensional position) of the object OBP to be constructed, and uses the obtained position of the object OBP to generate shape information of the object OBP. The procedure of generating the shape information is as described above.

In step S103, the construction information generation device 52 acquires the shape information from the detection device 51 to generate target construction information. In step S104, the construction information generation device 52 causes the storage unit of the construction information generation device 52 to store the generated target construction information. The procedure of generating the target construction information is as described above. In step S105, the excavator 1 constructs the object OBP to be constructed. At this time, the working-unit control device 56 performs working unit control. That is, the working-unit control device 56 moves a tooth point 8BT of the bucket 8 along a target shape represented by the target construction information and used for construction of the object OBP to be constructed.

In the present embodiment, the excavator 1 performs working unit control for construction, on the basis of the target construction information. On a construction site, the worker may perform manual excavation or the like using a working tool such as a shovel. In such a case, the worker may perform construction, such as excavation, while confirming the target construction information transmitted from the excavator 1 and acquired by the mobile terminal device 64.

In step S106, after the construction, the detection device 51 causes at least a pair of imaging devices 30 to capture images of the object OBP to be constructed after construction to generate shape information using the obtained images. Next, in step S107, the construction management device 57 transmits the shape information after construction generated by the detection device 51 to the management device 61. The construction management device 57 may transmit the shape information after construction to the mobile terminal device 64 illustrated in FIG. 3. The management device 61 after acquiring the shape information after construction may transmit the shape information to the mobile terminal device 64 illustrated in FIG. 3. In the flowchart illustrating an example of a process of the construction method illustrated in FIG. 14, step S106 and step S107 do not need to be performed.

In the present embodiment, for example, time and date when the shape information before construction or the shape information after construction is obtained by at least a pair of imaging devices 30 is acquired from a timer not illustrated. Information representing the acquired time and date is added to the shape information after construction. Furthermore, positional information representing a place where the shape information before construction or the shape information after construction is obtained by at least a pair of imaging devices 30 is acquired from the position detection device 23, and the acquired positional information is added to the shape information after construction.

Thus, at least one of the management device 61 and the mobile terminal device 64 can cause the shape information before/after construction on a predetermined construction site transmitted from the control system 50 to be displayed on the screen of the display device, thereby causing the progress of construction to be displayed. Furthermore, at least one of the management device 61 and the mobile terminal device 64 causes shape information of the predetermined construction site arranged in time-series to be displayed on the screen of the display device or to be displayed sequentially in frames, thereby causing the progress of construction on a daily basis to be displayed clearly.

In the present embodiment, the construction management device 57 may transmit, in addition to the shape information after construction, the target construction information to at least one of the management device 61 and the mobile terminal device 64. When the shape information after construction and the target construction information is transmitted only to the management device 61 from the excavator 1, the management device 61 may transmit the shape information after construction and the target construction information to the mobile terminal device 64. Thus, at least one of the management device 61 and the mobile terminal device 64 is allowed to display the shape information after construction and the target construction information on the screen of the display device in an aligned manner or in a superimposed manner, enabling the administrator or the like to promptly and easily confirm the progress of construction.

The control system 50 uses at least a pair of imaging devices 30 provided at the excavator 1 to detect the object to be constructed, determines the shape information of the object to be constructed on the basis of at least a pair of images as a result of the detection, and determines the shape information as the target shape information upon construction of the object on the basis of the obtained shape information. Accordingly, the control system 50 eliminates the need for the work of determining the shape of the object in accordance with the measurement of the object to be constructed performed by the worker by using a measurement device or the like on a construction site, and for the work of generating the target shape on the basis of the obtained object to be constructed, that is, the work of designing the target shape information. Therefore, the control system 50 can reduce time and effort to measure the current terrain of the object to be constructed and time and effort to determine the target shape of the object to be constructed upon construction thereof. The control system 50 can also generate the target construction information of a place where it is difficult for the worker to perform measurement using a measurement device or the like, as long as the imaging devices 30 can image the place. Therefore, construction by the work machine and manual construction such as manual excavation by the worker can be efficiently achieved. Furthermore, since the control system 50 can measure the object to be constructed, a burden on the worker performing measurement on construction site is reduced.

For example, when there is target construction information about the object to be constructed, which is created by a design tool, such as computer aided design (CAD), the work machine may need to be moved to a place indicated by the target construction information, that is, a place to be constructed to perform construction using the work machine. The excavator 1 including the control system 50 includes at least a pair of imaging devices 30 images the object to be constructed which is intended to be constructed by using at least a pair of imaging devices 30, and generates the target construction information on the basis of a result of the imaging. As described above, the excavator 1 functions as a measurement device and also functions as a design tool. That is, since the excavator 1 can generate, on construct site, the target construction information about the object to be constructed, the excavator 1 does not need to move to a place to be constructed. Thus, a travel time and a design time can be reduced, improving working efficiency.

In construction, the shape of an object to be constructed which is intended to be constructed may be different, compared with target construction information generated upon making a construction plan. For example, when an object to be constructed to which soil is to be added is covered with soil, not adding earth but removing the soil is required. Furthermore, when the soil of an object to be constructed which is to be excavated is washed away due to rain or the like, adding soil is required. In this case, the target construction information generated upon making a construction plan may be inappropriate. Before construction of the object to be constructed by the excavator 1, the control system 50 images the object to be constructed by using at least a pair of imaging devices 30, and generates target construction information on the basis of a result of imaging. That is, the control system 50 can generate appropriate target construction information on the basis of the shape of the object to be constructed immediately before construction.

The working unit control described above can achieve sophisticated work even by an unskilled operator of the excavator 1, but working unit control performed by the control system 50 cannot be achieved without the target construction information. Since even if there is no target construction information, the control system 50 images the object to be constructed which is intended to be constructed to generate the target construction information on the basis of a result of imaging, construction by working unit control can be achieved without preparing the target construction information in advance.

In the present embodiment, the control system 50 uses at least a pair of imaging devices 30 to obtain the shape information of the object OBP to be constructed, but the shape information may be obtained in accordance with another method. For example, the control system 50 may obtain the shape information by bringing part (tooth point 8BT) of the bucket 8 of the working unit 2 of the excavator 1 into contact with the object OBP to be constructed, to determine the position of the part of the bucket 8 brought into contact with the object OBP to be constructed on the basis of the attitude and dimensions of the working unit 2.

The configuration disclosed in the present embodiment may also be appropriately adapted in the following embodiments.

### Second Embodiment

In a second embodiment, on a construction site where a plurality of work machines works, the excavator 1 including the control system 50 acquires information about the object OBP to be constructed, to generate shape information and target construction information. Then, the excavator 1 transmits the generated target construction information to another work machine. The excavator 1 and the other work machine use the target construction information generated by the excavator 1, constructing the object OBP to be constructed. The other work machine may be, for example, a bulldozer, a wheel loader, and a grader, in addition to the other excavator 1ot illustrated in FIG. 3. The other work machine may or may not include the control system 50 but includes at least a communication device.

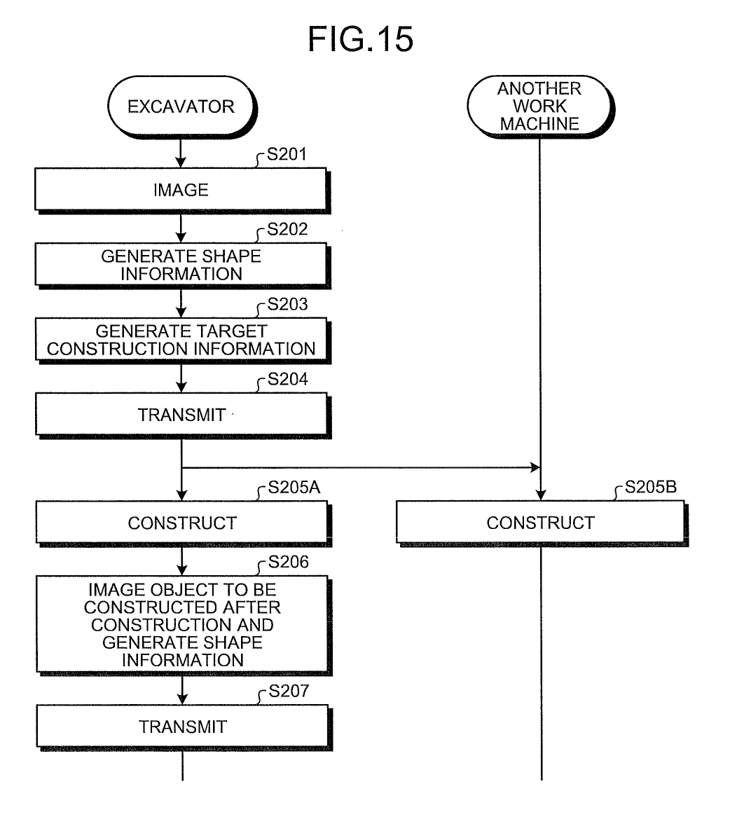

FIG. 15 is a flowchart illustrating an example of a process of a construction method according to a second embodiment. When the imaging switch 32 illustrated in FIG. 3 is operated by the operator to input the imaging command to the detection device 51, the detection device 51 causes at least a pair of imaging devices 30 to image the object OBP to be constructed, in step S201. At least a pair of imaging devices 30 images not only a range in which the excavator 1 performs construction, but also a range in which the other work machine working on the construction site, for example, the other excavator 1ot illustrated in FIG. 3 performs construction. The excavator 1 may move on the construction site to image the range to be constructed by the other work machine.

In step S202, the detection device 51 performs stereoscopic image processing on images captured by at least a pair of imaging devices 30, determines the position (three-dimensional position) of the object OBP to be constructed, and uses the obtained position of the object OBP to generate shape information of the object OBP. The procedure of generating the shape information is as described in the first embodiment.

In step S203, the construction information generation device 52 acquires the shape information from the detection device 51 to generate target construction information. The procedure of generating the target construction information is as described in the first embodiment. The construction information generation device 52 causes the storage unit of the construction information generation device 52 to store the generated target construction information. In this case, all of the generated target construction information, that is, the target construction information about the object OBP to be constructed for the excavator 1 and the target construction information about the object OBP to be constructed for the other work machine are stored in the storage unit of the construction information generation device 52. In step S203, to perform the next step S204, the control system 50 may transmit the target construction information to the other work machine immediately after the target construction information is generated, without storing the generated target construction information in the storage unit.

In step S204, the construction information generation device 52 or the construction management device 57 transmits the target construction information to the other work machine via the communication device 25 illustrated in FIG. 3. In step S205A, the excavator 1 uses the generated target construction information to construct the object OBP to be constructed. In step S205B, the other work machine uses the target construction information acquired from the excavator 1, constructing the object OBP to be constructed. The excavator 1 and the other work machine respectively include the working-unit control device 56, enabling working unit control according to the target construction information. In step S205A and step S205B, the excavator 1 and the other work machine respectively move a tooth point 8BT of the bucket 8 and the working unit 2 along a target shape represented by the target construction information and used for construction of the object OBP to be constructed.

The other work machine may not include the working-unit control device 56 to display, the construction guidance image, a positional relationship between the target construction information and the working unit 2 of the other work machine on the screen 58D of the display device 58. In this case, an operator of the other work machine operates the working unit 2 along the shape represented by the target construction information, while watching the screen 58D.

In step S206, after the construction, the detection device 51 causes at least a pair of imaging devices 30 to capture images of the object OBP to be constructed after construction to generate shape information using the obtained images. At this time, the detection device 51 also images the object OBP to be constructed which is constructed by the other work machine to generate shape information. The excavator 1 moves on the construction site or turns the swing body 3 to image a range constructed by the other work machine.

Next, in step S207, the construction management device 57 transmits shape information after construction generated by the detection device 51 to the management device 61. As in the first embodiment, the construction management device 57 may transmit the shape information after construction to the mobile terminal device 64 illustrated in FIG. 3, as well as transmit the target construction information, in addition to the shape information after construction, to at least one of the management device 61 and the mobile terminal device 64, and the like In the present embodiment, step S206 and step S207 may not be performed in the flowchart illustrating an example of a process of the construction method illustrated in FIG. 15.

The work machine including the control system 50, the excavator 1 in the present embodiment, generates target construction information about an object to be constructed for another work machine on a construction site. Therefore, when at least one work machine including the control system 50 is on the construction site, this work machine generates the target construction information about the construction site, and the other work machine can use the generated target construction information to perform construction. Thus, for example, even if a plurality of work machines perform construction on a construction site for which there is no target construction information, efficiency is improved.

The configurations disclosed in the present embodiment may also be appropriately adapted in the following embodiments.

### Third Embodiment

In a third embodiment, on a construction site where the excavator 1 works, the excavator 1 including the control system 50 acquires information about the object OBP to be constructed to generate shape information and transmits the generated shape information to the management device 61 in the management facility 60 illustrated in FIG. 3. The management device 61 uses the shape information acquired from the excavator 1 to generate target construction information and transmits the target construction information to the excavator 1. The excavator 1 uses the target construction information generated by the management device 61, constructing the object OBP to be constructed. In the present embodiment, the management device 61 generates the target construction information to reduce a load on the control system 50 of the excavator 1, in particular, the construction information generation device 52.

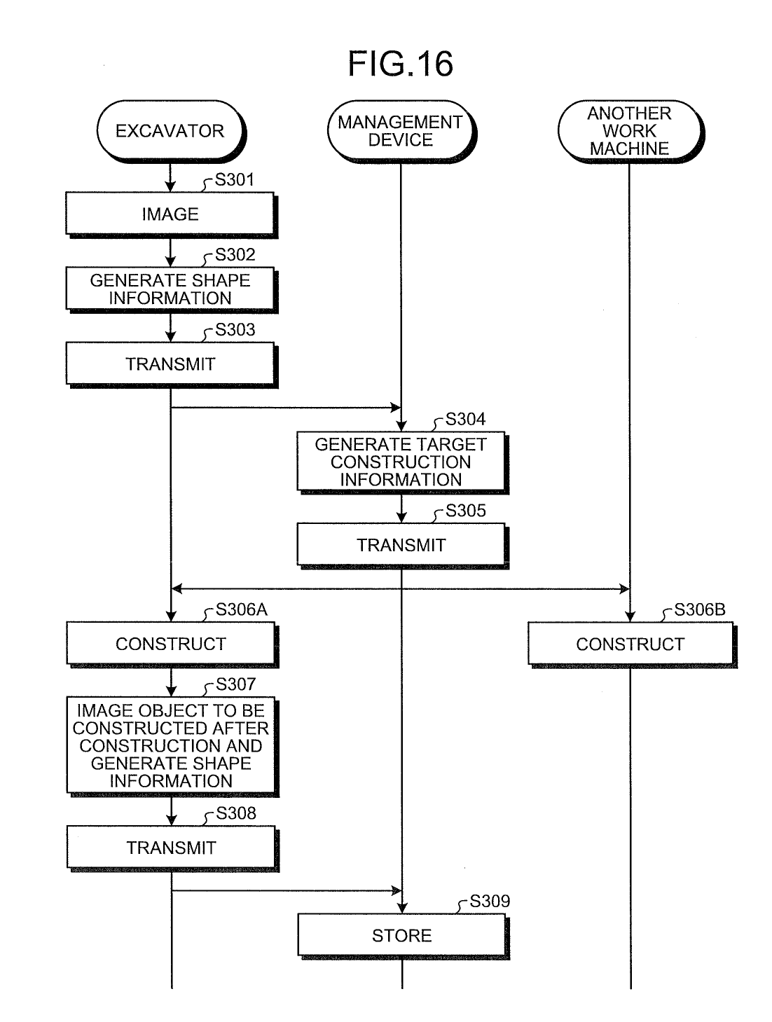

FIG. 16 is a flowchart illustrating an example of a process of a construction method according to the third embodiment. When the imaging switch 32 illustrated in FIG. 3 is operated by the operator to input the imaging command to the detection device 51, the detection device 51 causes at least a pair of imaging devices 30 to image the object OBP to be constructed, in step S301. At least a pair of imaging devices 30 images not only the range in which the excavator 1 performs construction but also the range in which another work machine working on the construction site, for example, the other excavator 1ot illustrated in FIG. 3 performs construction. The excavator 1 may move on the construction site to image the range to be constructed by the other work machine.

In step S302, the detection device 51 performs stereoscopic image processing on images captured by at least a pair of imaging devices 30, determines the position (three-dimensional position) of the object OBP to be constructed, and uses the obtained position of the object OBP to generate shape information of the object OBP The procedure of generating the shape information is as described in the first embodiment.

In step S303, the detection device 51 transmits the shape information to the management device 61 in the management facility 60 via the communication device 25 illustrated in FIG. 3. In step S304, the management device 61 generates the target construction information on the basis of the shape information acquired from the excavator 1. The generated target construction information is stored in the storage unit of the management device 61. The procedure of generating the target construction information is as described in the first embodiment.

In step S305, the management device 61 transmits the generated target construction information to the excavator 1 and the other work machine via the communication device 62 in the management facility 60. In step S306A, the excavator 1 uses the target construction information acquired from the management device 61, constructing the object OBP to be constructed. In step S306B, the other work machine uses the target construction information acquired from the management device 61, constructing the object OBP to be constructed. In step S306A and step S306B, the excavator 1 and the other work machine move a tooth point 8BT of the bucket 8 and the working unit 2 along a target shape represented by the target construction information and used for construction of the object OBP to be constructed.

At least one of the excavator 1 and the other work machine may not include the working-unit control device 56 and may be able to display, as the construction guidance image, a positional relationship between the target construction information and the working unit 2 of the other work machine on the screen 58D of the display device 58. As described in the second embodiment, the operator operates the working unit 2 along the shape represented by the target construction information, while watching the screen 58D.

In step S307, after the construction, the detection device 51 of the excavator 1 causes at least a pair of imaging devices 30 to capture images of the object OBP to be constructed after construction to generate shape information using the obtained images. At this time, the detection device 51 also images the object OBP to be constructed which is constructed by the other work machine to generate shape information. Next, in step S308, the construction management device 57 transmits the shape information after construction generated by the detection device 51 to the management device 61. In step S309, the management device 61 after acquiring the shape information after construction causes the storage unit to store the shape information. The management device 61 may transmit the shape information after construction to the mobile terminal device 64 illustrated in FIG. 3.

First Modification

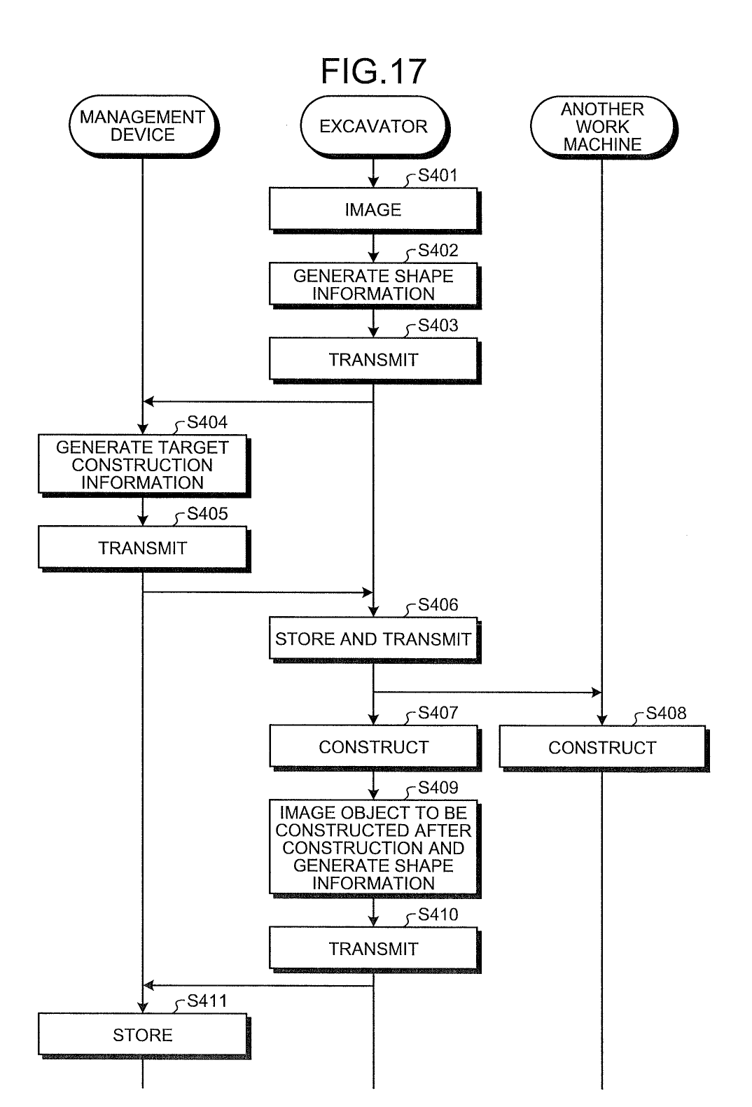

FIG. 17 is a flowchart illustrating an example of a process of a construction method according to a first modification of the third embodiment. In the first modification, the target construction information generated by the management device 61 is different from that of the third embodiment described above because it is transmitted to the other work machine via the excavator 1 including the control system 50. Step S401 to step S405 are similar to step S301 to step S305 of the third embodiment and the description thereof will not be repeated. In step S406, the construction management device 57 of the control system 50 of the excavator 1 after acquiring the target construction information from the management device 61 causes the storage unit of the construction management device 57 to store the target construction information and transmits the target construction information to the other work machine via the communication device 25.

In step S407, the excavator 1 uses the target construction information acquired from the management device 61, constructing the object OBP to be constructed. In step S408, the other work machine uses the target construction information acquired from the management device 61 via the excavator 1, constructing the object OBP to be constructed. Construction in step S407 and step S408 is similar to the construction in step S306A and step S306B in the third embodiment.

In step S409, after the construction, the detection device 51 of the excavator 1 causes at least a pair of imaging devices 30 to capture images of the object OBP to be constructed after construction to generate shape information using the obtained images. At this time, the detection device 51 also images the object OBP to be constructed which is constructed by the other work machine to generate shape information. Next, in step S410, the construction management device 57 transmits the shape information after construction generated by the detection device 51 to the management device 61. In step S411, the management device 61 after acquiring the shape information after construction causes the storage unit to store the shape information. The management device 61 may transmit the shape information after construction to the mobile terminal device 64 illustrated in FIG. 3.

Second Modification

In a second modification, a construction method is provided for construction performed by a plurality of the excavators 1 including the control systems 50 on a construction site. In the second modification, shape information generated by each of the excavators 1 is transmitted to the management device 61, the management device 61 generates target construction information acquired from each excavator 1, and transmits the target construction information to each excavator 1. Each of the excavators 1 performs construction by using the target construction information acquired from the management device 61.

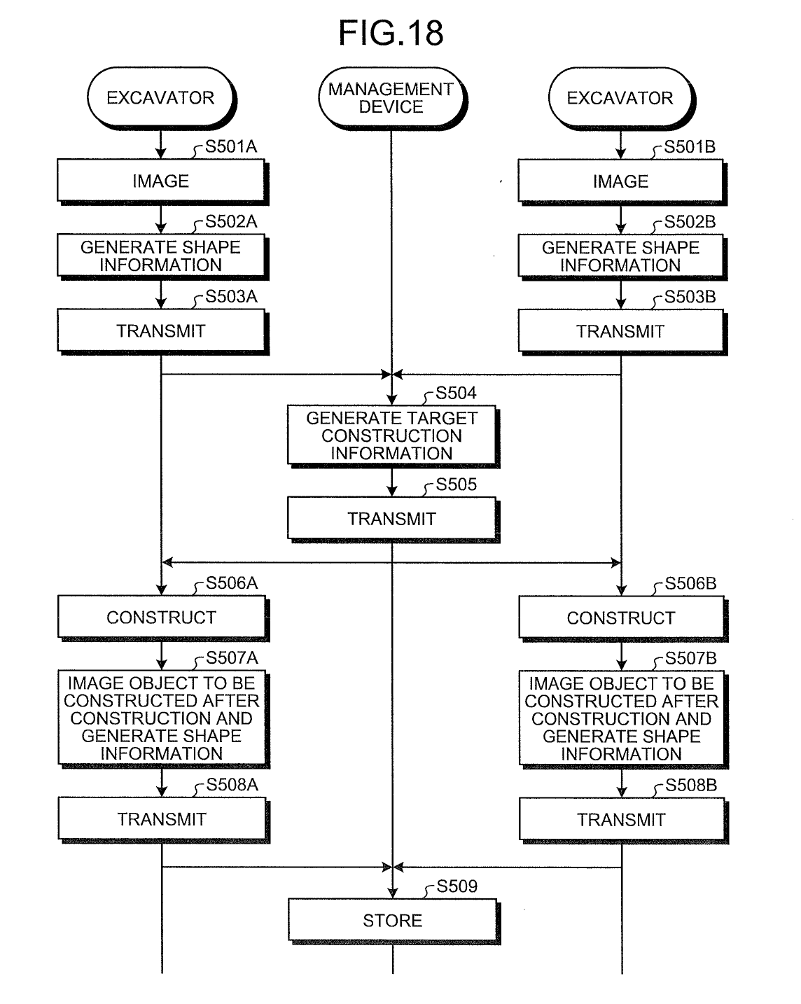

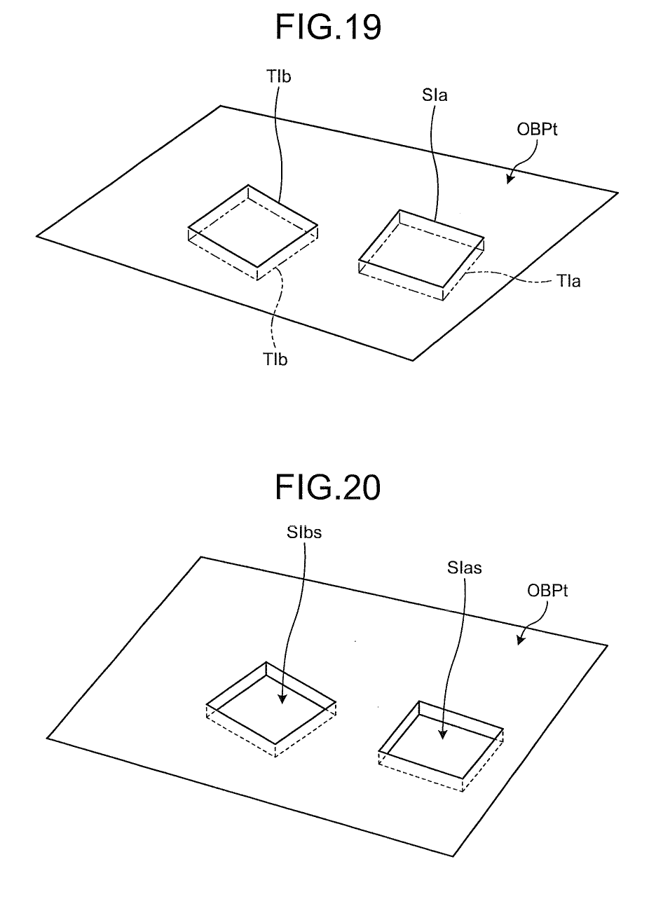

FIG. 18 is a flowchart illustrating an example of a process of the construction method according to the second modification of the third embodiment. FIGS. 19 and FIG. 20 are diagrams illustrating the construction method according to the second modification of the third embodiment. In the following description, it is assumed that two excavators 1 perform construction on a construction site. One excavator 1 is represented by an excavator 1a, and another excavator 1 is represented as an excavator 1b, for convenience. In the present modification, the number of excavators 1 performing construction on the construction site is not limited to two.

Step S501A to step S503A and step S501B to step S503B are similar to step S301 to step S303 of the third embodiment and the description thereof will not be repeated. In step S504, the management device 61 generates the target construction information on the basis of the shape information acquired from the excavator 1. The generated target construction information is stored in the storage unit of the management device 61. The procedure of generating the target construction information is as described in the first embodiment. As illustrated in FIG. 19, shape information SIa and SIb acquired from the excavators 1a and 1b is part of the object OBPt to be constructed as the whole construction site. The management device 61 generates target construction information TIa and TIb corresponding to the shape information SIa and SIb. In step S505, the management device 61 transmits the generated target construction information to the excavators 1a and 1b via the communication device 62 in the management facility 60.

The construction management devices 57 of the control systems 50 of the excavators 1a and 1b that have acquired the target construction information TIa and TIb from the management device 61 cause the storage units of the construction management devices 57 to store the respective target construction information TIa and TIb. In step S506A and step S506B, the excavators la and lb use the target construction information TIa and TIb acquired from the management device 61, constructing the object OBP to be constructed. Construction in step S506A and step S506B is similar to the construction in step S306A and step S306B in the third embodiment.

In step S507A and step S507B, after the construction, each of the detection devices 51 of the excavators 1a and 1b causes at least a pair of imaging devices 30 to capture images of the object OBP to be constructed after construction to generate shape information using the obtained images. Next, in step S508A and step S508B, each of the construction management devices 57 of the excavators la and lb transmits shape information after construction generated by the detection device 51 to the management device 61. In step S509, the management device 61 after acquiring the shape information after construction causes the storage unit to store the shape information. The management device 61 may transmit the shape information after construction to the mobile terminal device 64 illustrated in FIG. 3.

FIG. 20 illustrates a state in which shape information Slas and SIbs after construction is displayed on the object OBPt to be constructed as the whole construction site. As described above, the shape information Slas and SIbs after construction is combined with the object OBPt to be constructed as the whole construction site, facilitating understanding of the progress of construction by the administrator.

In the present embodiment and the modifications thereof, the management device 61 uses the shape information transmitted from the excavator including the control system 50 to generate the target construction information, enabling the reduction of a load on the control system 50. The configurations disclosed in the present embodiment may also be appropriately adapted in the following embodiments.

### Fourth Embodiment

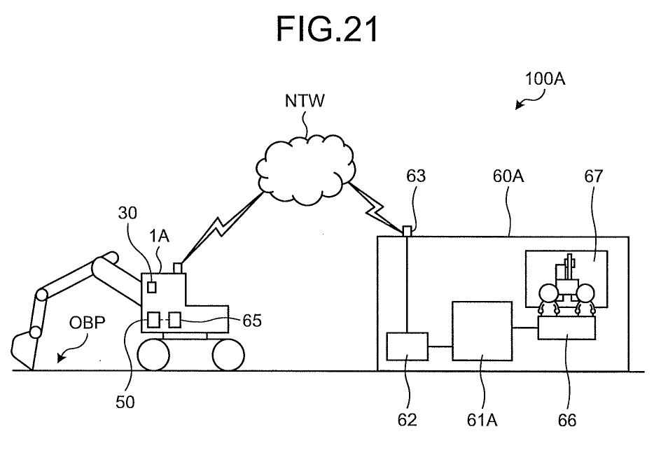

FIG. 21 is a diagram illustrating a management system 100A according to a fourth embodiment. The management system 100A is a system in which an excavator 1A is remotely controlled by an operation device 66 of a management facility 60A. The excavator 1A is a work machine including a remote control device 65, in addition to the control system 50 of the excavator 1 according to the first to third embodiments. The management facility 60A includes a management device 61A which uses input from the operation device 66 to generate an operation command for controlling the excavator 1A and transmits the operation command via the communication device 62 and an antenna 63. The remote control device 65 of the excavator 1A acquires the operation command via communication line NTW and controls the excavator 1A via the control system 50.

At least one of shape information and target construction information generated by the control system 50 of the excavator 1A is acquired by the management device 61A, and is used for management of construction. In the management facility 60A, during construction by the excavator 1A, the operator operates the operation device 66 while causing a display device 67 to display an image of the object OBP to be constructed. During operation of the excavator 1A, at least a pair of imaging devices 30 of the excavator 1A may image the object OBP to be constructed, or an imaging device different from the imaging device 30 may image the object OBP to be constructed. At least a pair of imaging devices 30 is preferably configured to image the object OBP to be constructed during operation of the excavator 1A to eliminate the provision of another imaging device at the excavator 1A.

The embodiments have been described above, but the embodiments are not limited to the above description. Furthermore, the above-mentioned components include components conceived by those skilled in the art and substantially identical components, that is, so-called equivalents. The above-mentioned components may be appropriately combined with each other. At least one of various omission, substitution, and alteration of the components may be made without departing from the spirit of the invention. As long as the work machine can perform construction, such as excavation or transport, of the object to be constructed, the work machine is not limited to the excavator and may be work machine, such as a wheel loader and a bulldozer.

### REFERENCE SIGNS LIST

1, 1A, 1a, 1b EXCAVATOR

2 WORKING UNIT

3 SWING BODY

4 CAB

5 TRAVEL BODY

8 BUCKET

8BT TOOTH POINT

21, 22 ANTENNA

23 POSITION DETECTING DEVICE

25 COMMUNICATION DEVICE

27 INTERNAL COMBUSTION ENGINE

28 HYDRAULIC PUMP

29 CONTROL VALVE

30a, 30b, 30c, 30d IMAGING DEVICE

50 WORK MACHINE CONTROL SYSTEM

51 DETECTION DEVICE

52 CONSTRUCTION INFORMATION GENERATION DEVICE

53 SENSOR CONTROL DEVICE

54 ENGINE CONTROL DEVICE

55 PUMP CONTROL DEVICE

56 WORKING-UNIT CONTROL DEVICE

57 CONSTRUCTION MANAGEMENT DEVICE

58 DISPLAY DEVICE

59 SIGNAL LINE

60, 60A MANAGEMENT FACILITY

61, 61A MANAGEMENT DEVICE

62 COMMUNICATION DEVICE

64 MOBILE TERMINAL DEVICE

65 REMOTE CONTROL DEVICE

100, 100A WORK MACHINE MANAGEMENT SYSTEM

EMD DATA FILE

IO INPUT-OUTPUT UNIT

MR STORAGE UNIT

NTW COMMUNICATION LINE

PR PROCESSING UNIT

1. A construction method comprising:
acquiring information about an object detected by an object detection unit of a work machine;
determining shape information representing a three-dimensional shape of the object on the basis of the acquired information about the object; and
determining, by changing a position of a surface of the object included in the shape information, target construction information as a target of construction of the object by a work machine.

2. The construction method according to claim 1, wherein the work machine includes a working unit, and the working unit is controlled on the basis of the target construction information.

3. (canceled)

4. The construction method according to claim 1, wherein the changing the position of the surface of the object includes offsetting the surface of the object by a predetermined depth or a predetermined height.

5. The construction method according to claim 1, wherein the changing the position of the surface of the object includes providing a slope having a predetermined angle of inclination on the surface of the object.

6. A work machine control system comprising:
an object detection unit configured to detect an object and output information about the object;
a shape detection unit configured to, by using information about the object detected by the object detection unit, output shape information representing a three-dimensional shape of the object; and
a construction information generation unit configured to acquire the shape information from the shape detection unit and determine, by changing a position of a surface of the object included in the shape information, target construction information as a target of construction of the object.

7. The work machine control system according to claim 6, further comprising a working unit control unit configured to control the working unit on the basis of the target construction information.

8. The work machine control system according to claim 6, further comprising a display device configured to display a shape of the target represented by the target construction information.

9. The work machine control system according to claim 6, wherein the construction information generation unit is configured to change a position of a surface of the object included in the shape information to determine the target construction information.

10. The work machine control system according to claim 6, wherein the shape detection unit includes at least two imaging devices.

11. A work machine comprising the work machine control system according to claim 6.

12. A work machine comprising the work machine control system according to claim 6, the work machine being remotely controlled by a remote control device.
